(19) United States
(12) Patent Application Publication
(10) Pub. No.: US 2010/0314145 A1
(43) Pub. Date: Dec. 16, 2010

(54) TURF ROLLER

(76) Inventor: Eric Merkt, Athens, AL (US)

Correspondence Address: NEXSEN PRUET, LLC, P.O. BOX 10648, GREENVILLE, SC, 29603, US

(21) Appl. No.: 12/446,034

(22) PCT Filed: Nov. 19, 2007
(86) PCT No.: PCT/US07/85126

§ 371 Date: Apr. 17, 2009

Related U.S. Application Data
(60) Provisional application No. 60/859,749, filed on Nov. 17, 2006.

(51) Int. Cl. A01B 29/02; A01G 1/12; A01B 45/00

(52) U.S. Cl. 172/610

(57) ABSTRACT

A turf roller includes a water filled, cylindrical roller drum with smoothed hemispherical ends adapted to eliminate sharp edges of a regular cylinder. The roller drum is suspended from a roller frame having a towing tongue and bracing attached. A heavy duty front scrapper blade is disposed along the length of the front of the drum to scrape mud and debris from the rolling surface of the drum. A second, rear scrapper blade and a grass catching basket are disposed along the length of the rear of the drum to scrape and retain grass clippings from the rolling surface of the drum. High speed transport wheels are extendable by a hydraulic system and mechanical linkages to lift the roller from the turf surface for high speed transport. The high speed transport wheels are retractable above the surface for low speed turf rolling operations. The hydraulic system is preferably operated remotely by a tow vehicle operator.

### BACKGROUND OF THE INVENTION

The present invention relates generally to an apparatus and method of compacting and leveling a ground surface. More particularly, this invention pertains to an apparatus and method for compacting and leveling a ground substrate prior to the installation of turf and for compacting a surface of turf installed upon a prepared ground substrate.

Turf rolling is a preferred practice widely known and used during the installation of turf on residential lawns, golf courses, athletic fields and institutional grounds. Prior to installation of the turf, rolling with a turf roller compacts and stabilizes the soil to form a ground substrate suitable for the installation of turf. After the installation of turf, rolling helps remove air pockets and to further stabilize the soil to ensure good contact between the roots and soil.

Seasonable and other maintenance rolling serves to tighten the thatch layer to increase durability of the turf. In the maintenance of golf courses and putting greens, turf rolling reduces spike marks on greens and reduces footmarks during wet weather. In the maintenance of athletic fields, turf rolling reduces cleat marks and smoothes the turf surface after aerificaiton and top dressing.

Turf rollers come in various sizes and may be self-propelled, towed or pushed. Towed turf rollers are typically larger than self-propelled or pushed rollers and are generally used in larger applications such as golf courses and athletic field maintenance. Common towed turf rollers typically incorporate a water filled, cylindrical drum attached as a rolling mechanism. The drum is attached to a tow frame for towing by a tractor or a similar vehicle. One common disadvantage of the cylindrical rollers is their tendency to leave marks in the turf surface caused by the edges at both ends of the cylindrical rollers. Another common disadvantage of cylindrical rollers is their tendency to gather mud, dirt, grass clippings and other debris on the roller surface. Such debris, if not removed, is pressed into the surface of the turf and may leave marks in the surface of the turf and/or debris embedded in the grass layer or the thatch layer.

What is needed is a turf roller adapted for use in large areas, such as golf courses and athletic fields, that does not leave marks caused by sharp edges such as those caused by a cylindrical drum roller.

What is also needed is a turf roller adapted to remove debris from the roller surface and prevent its deposit on the turf surface.

Also what is needed is a turf roller adapted to be towed by a vehicle at low speeds during turf rolling operations and to be towed at high speed during transport operation.

### BRIEF SUMMARY OF THE INVENTION

A turf roller of a preferred embodiment of the present invention includes a water filled, cylindrical roller drum with smoothed hemispherical ends adapted to eliminate sharp edges of a regular cylinder. The roller drum is suspended from a roller frame having a towing tongue and bracing attached. A heavy duty front scrapper blade is disposed along the length of the front of the drum to scrape mud, dirt and debris from the rolling surface of the drum. A second, rear scrapper blade and a grass basket is disposed along the length of the rear of the drum to scrape and retain grass clippings from the rolling surface of the drum. High speed transport wheels are extended by a hydraulic system and mechanical linkages to lift the roller from the turf surface for high speed transport. The high speed transport wheels are retracted and lifted above the surface for low speed turf rolling operations by the hydraulic system and mechanical linkages. The hydraulic system is operated remotely by the tow vehicle operator.

Advantageously, the turf roller's cylindrical drum with smoothed hemispherical ends eliminates sharp edges that would mark the turf during rolling, especially in turning the turf roller.

Also advantageously, the turf roller is adapted to incorporate both a front debris scrapper and a rear grass clipping scraper adapted to remove debris from the roller surface and prevent its deposit on the turf surface.

Also advantageously, the turf roller is adapted to have remotely operated hydraulically extendable and retractable high speed transit wheels that allow the roller to be towed by a vehicle at low speeds during turf rolling operations and to be towed at high speeds during transport operations.

### BRIEF DESCRIPTION OF THE SEVERAL VIEWS OF THE DRAWINGS

The invention is illustrated in the accompanying drawings, in which;

FIG. 1 is an overhead view of one preferred embodiment of the present invention showing a towed, fluid drum turf roller capable of both low speed turf rolling and high speed transport;

FIG. 2 is a left side view of the turf roller of FIG. 1 with the high speed transport wheels assembly raised for low speed turf rolling;

FIG. 3 is a second left side view of the turf roller of FIG. 1 with the high speed transport wheels lowered for high speed transport;

FIG. 4 is a front view of the turf roller FIG. 1;

FIG. 5 is a rear view of the turf roller of FIG. 1, and

FIG. 6 is a detailed view of the wheel locking mechanism of the turf roller of FIG. 1.

### DETAILED DESCRIPTION OF THE INVENTION

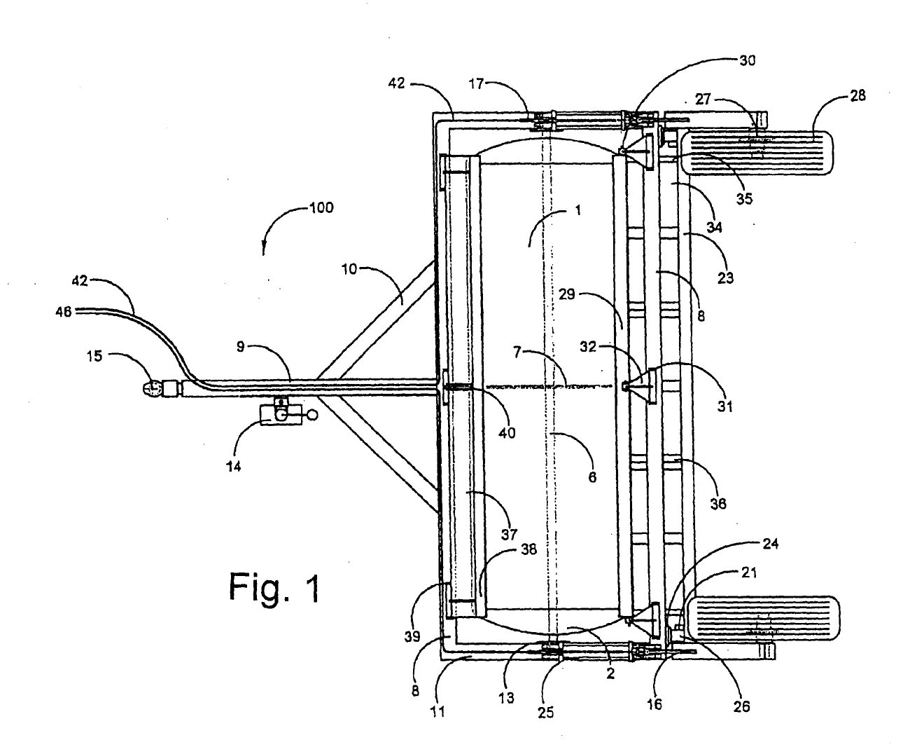

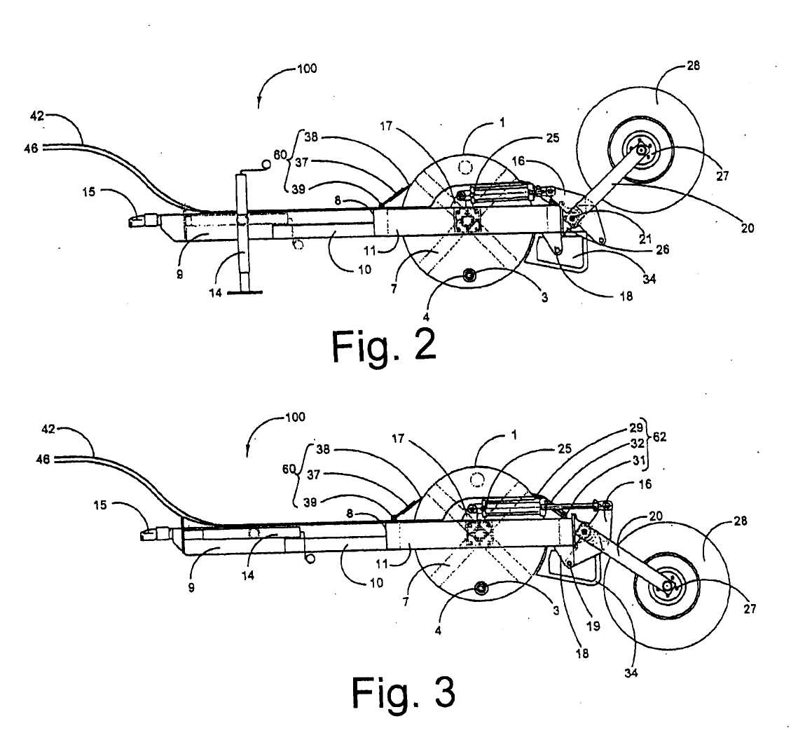

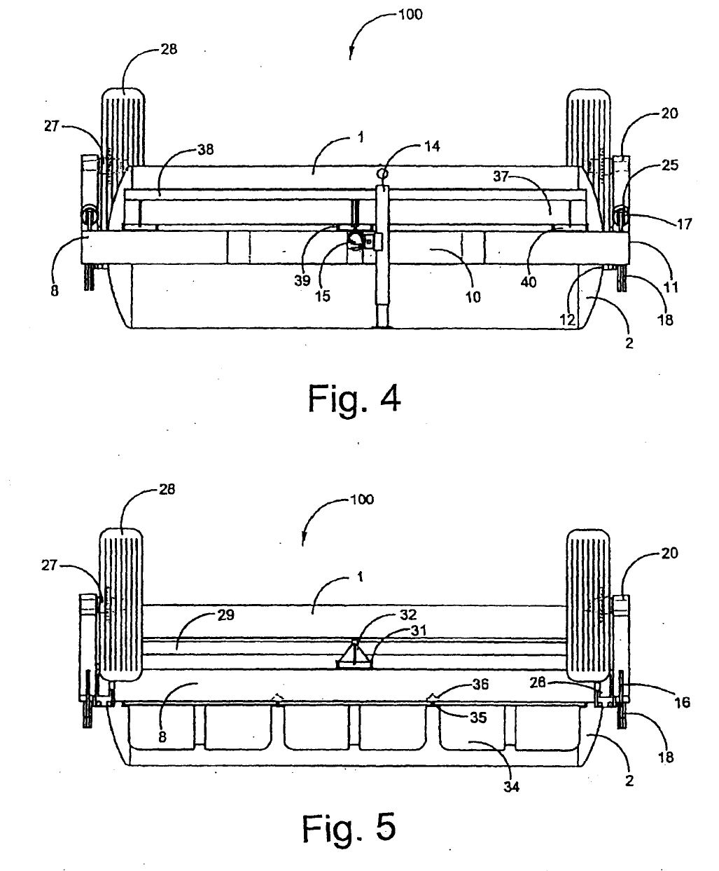

A preferred embodiment of the turf roller of the present invention is shown in FIGS. 1 through 6 and described below. Referring to FIGS. 1-3, a preferred embodiment of the turf roller 100 includes a cylindrical hollow drum roller 1 having a smooth cylindrical surface and having two smooth hemispherical ends 2. A drain plug 3 and a drain sleeve 4 are mounted in each of the roller ends 2. The drain plug 3 is threaded into the drain sleeve 4 and both are oversized for easier filling and draining. The sleeve and plug are recessed so as not to extend axially beyond the roller ends. The turf roller 100 is supported on a roller shaft 6 by internal roller braces 7 shown in broken lines in FIGS. 2 and 3. The roller shaft 6 is rotatably mounted on the lateral sides of frame 8, which is attached to a frame tongue 9 that is supported by frame tongue braces 10. The turf roller 100 is adapted for towing by a vehicle, such as a tractor, by means of a hitch 16 attached to the distal end of the roller tongue 9. A tongue jack 14 is provided for support of the tongue 9 when not being towed.

A pair of laterally spaced rear transit wheels 28 are attached to the frame 8 by left and right transports legs 20 pivotally connected to laterally opposite sides of the frame. The rear wheels 28 may be retracted, as shown in FIG. 2, for operation of the turf roller 100 in the low speed mode for rolling of a turf surface. In one embodiment of the turf roller 100, the transit wheels may be positioned in either the fully retracted or in the fully extended position. In another embodiment of the turf roller, the transit wheels may be positioned in selected intermediate positions between the fully retracted and in the fully extended position. As shown in FIG. 3, the rear wheels 28 may be deployed in an extended fashion to a position below the drum roller 1, thereby raising the frame 8 and the roller 1 above the latter's contact point with the ground surface. The rear wheels 28 are raised and lowered by means of a pair of hydraulic cylinders 25, which are disposed along the left and right sides of the frame 8. Each hydraulic cylinder 25 is supported on its front end by pivotal attachment to a cylinder bracket 17 welded to the frame 8. The rear portion of each hydraulic cylinder 25 is attached to a transport bracket 16, which is rigidly secured to the forward end of a transport leg 20 to which a rear wheel 28 is distally mounted.

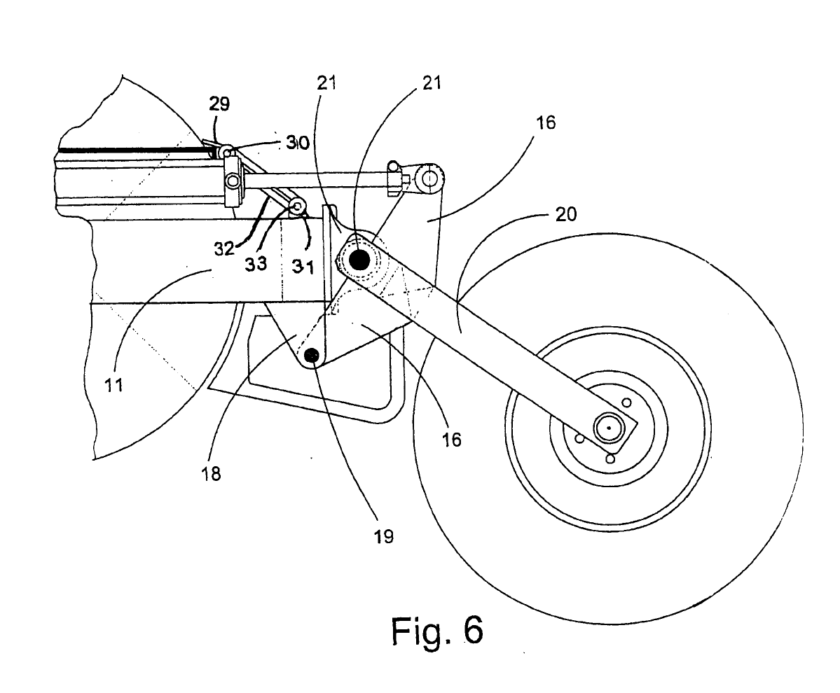

A laterally extended horizontal transport shaft 21 extends through each transport leg 20 so as to pivotally connect the leg 20 to the frame 8 for extending or retracting the wheels 28 thereby providing structural support for the frame 8 when the wheels 28 are extended to engage the ground for operation in the high speed transport mode. Advantageously, the wheel 28 can be locked in the extended position as shown in FIG. 6 by means of positioning a transport pin 19 in alienable holes in a transport lock bracket 18 and the transport bracket 16. If hydraulic pressure is lost while the wheels are in an extended position without the pin attached, the weight of the drum roller 1 would contact the ground during high speed transit. However, with the locking pin installed, loss of hydraulic pressure has no effect on the relative position of the extended wheel 28 and the drum roller 1 or roller frame 8.

For each hydraulic cylinder 25, a hydraulic conduit or hose 42 is attached at one end of the hydraulic cylinder 25 and at the other end to a hydraulic coupler 46 for attachment to a hydraulic source and actuator means (now shown). Advantageously, the tow vehicle operator can remotely operate the hydraulic actuator so as to lift or lower the drum roller 1 without the need of exiting the vehicle.

As shown in FIGS. 2, 3 and 5, a grass catcher basket 34 is disposed adjacent the rear of the drum roller 1 and is supported by the frame 8 and frame sides 11. A rear scraper 62 is disposed upon the rear frame 8 so as to contact the rear portion of the drum roller 1 as it rotates in a counter clockwise direction as shown in FIGS. 2 and 3. The rear scraper 62 includes a grass scraper angle blade 29 making contact with the surface of the drum roller 1. The rear scraper blade 29 and the grass catcher basket 34 are co-extensive with the axial length of the cylindrical surface of the drum roller 1. As shown in FIG. 1 the rear scrapper blade 29 is supported by three hinge assemblies, one such hinge assembly mounted in the center of the blade 29 and the other hinge assemblies mounted on either end of the blade 29. The hinge assemblies each include a grass scrapper pivot plate 32 connected to the grass scrapper blade 29 by the grass scrapper hinge pin 30. Each grass scrapper pivot plate 32 is rotatably attached to a grass scrapper pivot mount 31 by a grass scrapper pivot pin 33. Each grass scrapper pivot mount 31 is affixed to the frame 8 by welding. In operation of the turf roller 100, the rear scrapper 62 removes grass and other debris clinging to the drum roller surface as the drum roller 1 rotates beneath the rear scrapper 62. The grass and debris collects in the grass catcher basket 34 disposed below the rear scrapper 62.

A front scrapper 62 is disposed on the frame 8 at the front of the drum roller 1 and is adapted to scrape mud and debris from the cylindrical drum roller surface that were not scraped from the surface by the rear grass scrapper 62. The front scrapper 60 includes a mud scrapper blade 38 extending laterally the full axial length of the cylindrical drum surface and making contact with the cylindrical surface of the drum roller 1. The blade 38 is affixed to a mud scrapper base 37 and both extend laterally across the front cylindrical surface of the drum roller 1. Mud scrapper pivots 40 are affixed in the center and laterally opposite ends, respectively, of the base 37. A scrapper pivot mounts 39 are welded to the front of the frame 8 and connected respectively to the mud scrapper pivots 40 by the mud scrapper pivot pin 41. In operation of the turf roller 100, the front scrapper 60 faces rearward and opposite the direction of rotation of the drum roller 1. The front scrapper 60 removes mud and other debris still clinging to the drum roller surface as the drum roller 1 rotates.

Thus, although there have been described particular embodiments of the present invention of a new and useful turf roller, it is not intended that such references be construed as limitations upon the scope of this invention except as set forth in the following claims.

What is claimed is:

1. A turf roller comprising:
a cylindrical drum roller with a cylindrical ground engaging rolling surface and hemispherical ends connecting in a smooth transition from axially opposite ends, respectively, of said cylindrical surface;
a roller support frame having a forward extending towing tongue adapted for connection at its front end to a tow vehicle, said support frame being pivotally connected to said drum roller on its axis extending transverse to the direction of towing;
a front scrapper blade pivotally mounted on said frame and disposed along the length of the front of the drum and adapted to scrape mud and debris from said cylindrical surface of said drum;
a rear scrapper blade and a grass catching basket, both of which are mounted on said frame and disposed along the length of the rear of the drum, said rear scrapper blade being adapted to scrape grass clippings from said cylindrical surface of said drum and said grass catching basket being disposed below said rear scrapper blade and adapted to catch and retain said scrapped clippings;
a pair of laterally spaced ground engageable support wheels,
a pair of laterally spaced support legs having first corresponding ends pivotally connected to laterally opposite sides of said support frame on a first horizontal transverse axis and second corresponding ends rotatably supporting said wheels on a second horizontal transverse axis and
a linear fluid actuator interposed between each of said legs and said support frame, said fluid actuators being operable to adjust the elevation of said drum roller between a lowered turf engaging position and a raised transport position.

2. The turf roller of claim 1 wherein said support wheels are positioned behind laterally opposite sides, respectively, of said support frame.

3. The turf roller of claim 2 including alignable transverse openings in said legs and said support frame spaced from said first transverse axis, said alignable openings being adapted to receive a locking pin operating to maintain said wheels in a lowered position relative to said frame in which said drum roller is raised from the ground.

4. The turf roller of claim 1 including a sleeve and drain plug recessed into each end of said roller, each drain plug being a disposed within the associated sleeve.
